(19) United States
(12) Patent Application Publication
(10) Pub. No.: US 2004/0122901 A1
(43) Pub. Date: Jun. 24, 2004

(54) Providing computer presence information to an integrated presence system

(75) Inventor: Dany Sylvain, Gatineau (CA)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 10/325,144

(22) Filed: Dec. 20, 2002

(51) Int. Cl. G06F 15/16

(52) U.S. Cl. 709/206

(57) ABSTRACT

The present invention allows a traditional computer presence system to automatically provide state information to an integrated presence system. The integrated presence system will register as a user with the computer presence system. As such, the integrated presence system can be added to a buddy list of a user who is registered with the computer presence system. To configure the computer presence system to provide state information for the second user to the integrated presence system, the second user will add the integrated presence system to her buddy list, and as such, any state information kept by the computer presence system for the second user will be provided to the integrated presence system. The integrated presence system may take the state information and create presence information to send to subscribers to the integrated presence system.

### FIELD OF THE INVENTION

The present invention relates to communications, and in particular to providing presence information from a computer-based presence system to an integrated presence system capable of monitoring state information from different types of devices to provide a more comprehensive view of a party's availability.

### BACKGROUND OF THE INVENTION

Presence technology is used to convey information about the availability of individuals. Individuals are often interested in the availability of others, and, because they are often not co-located, they require mechanisms for conveying availability or status information. The devices that people interact with know bits and pieces about how available they are for communications or other forms of interaction with others at any instant. People that are on the telephone are less available to most others for the duration of the call, but may want to be interrupted by selected callers. Nortel Networks Limited is developing integrated presence systems, which are capable of monitoring state information from various types of devices with which a user interacts and compiling the state information to provide presence information, which is capable of providing an accurate depiction of a user's availability to subscribers interested therein.

A major hurdle in providing an integrated presence system is interacting with different devices over different networks using different communication technologies to obtain the various state information from which presence information bearing on the availability of the user can be derived. In these systems, state information can be derived from telephony switches, telephone systems, personal computers, internet appliances, and virtually any other device capable of providing information bearing on the status of an individual. Obtaining state information from these different devices has proven to provide presence information with a high level of granularity to give subscribers a very accurate view of the individual's availability for communications, and how such communications should be initiated. These systems are proving to be much more valuable than the rudimentary computer-focused presence systems, which are implemented in dedicated computer-based applications. A common example of a computer-focused presence system is found in most instant messaging (IM) applications, wherein users can determine whether their buddies are logged in, as well as determine how active their buddies have been in the current session. Such presence information is coarse at best, and is unable to provide a detailed view of availability, especially when a user is logged in to the instant messaging service yet is in an idle mode. At this point, the buddies are unable to determine whether the user is physically at the computer and simply not participating in the instant messaging session, or if the user has actually left the computer without logging off of the session.

Although the computer-focused presence systems are coarse, the basic state information would be beneficial to an integrated presence system, wherein the state information associated with the instant messaging session could be combined with other state information from the user's office and mobile telephones, or computer activity could be processed to provide a very clear determination of the user's availability. Thus, there is a need for an efficient and unobtrusive way to provide state information from computer-focused presence systems to an integrated presence system to provide a more accurate and global sense of a user's availability.

### SUMMARY OF THE INVENTION

The present invention allows a traditional computer presence system to automatically provide state information about computer presence users to an integrated presence system. The integrated presence system will register as a user with the computer presence system. As such, the integrated presence system can be added to a buddy list of a user who is registered with the computer presence system. To configure the computer presence system to provide state information for a second user of the integrated presence system, the second user will add the integrated presence system to her buddy list, and as such, any state information kept by the computer presence system for the second user will be provided to the integrated presence system. In order to correlate the computer presence information of the second user with the presence information from other sources for the second user, the integrated presence system can interact with the second user's devices, excluding the second user's computer, to obtain authentication information related to the second user. Subsequently, the integrated presence system can interact with the second user via the computer presence system to verify the information received from the second user through the alternative source to authenticate the second user. Once authenticated, the integrated presence system will associate the computer presence information for the second user with the alternate presence sources for the second user and provide an integrated presence view to other users of the integrated presence system.

In one embodiment, the computer presence system is provided by a traditional instant messaging service, wherein the interaction between the user and the integrated presence system is carried out via instant messaging, and the state information provided to the integrated presence system are states monitored by the instant messaging system. Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment constructed according to one embodiment of the present invention.

FIG. 2 is a logical representation of a presence system according to one embodiment of the present invention.

FIG. 3 is a flow diagram outlining a provisioning process according to one embodiment of the present invention.

FIG. 4 is a flow diagram outlining overall operation of a presence system according to one embodiment of the present invention.

FIG. 5 is a flow diagram outlining the processing of state information according to one embodiment of the present invention.

FIG. 6 is a communication flow outlining an exemplary process for automatically providing state information from a telephony system.

FIG. 7 is a communication environment according to a first embodiment of the present invention.

FIGS. 8A-8D are a communication flow diagram illustrating operation of one embodiment of the present invention.

FIG. 9 is a block representation of a telephony switch constructed according to one embodiment of the present invention.

FIG. 10 is a block representation of a presence server for implementing the integrated presence system according to one embodiment of the present invention.

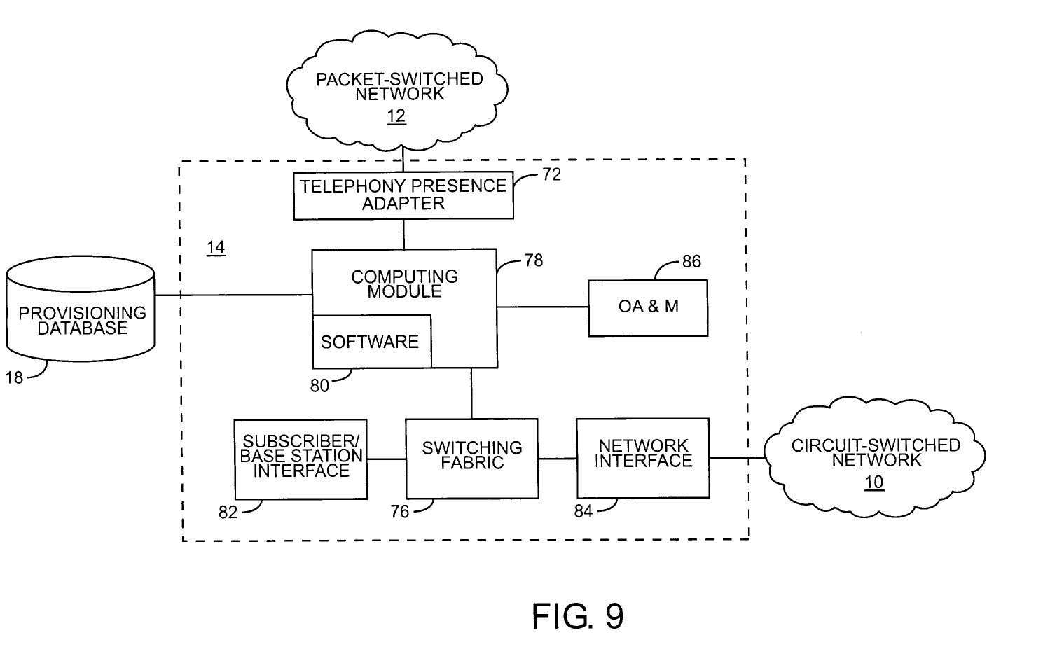

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention provides an effective way to automatically provide state information from a computer presence system to an integrated presence system. As noted, presence technology is used to convey information about the availability of individuals. Individuals are often interested in the availability of others and, because they are often not co-located, they require mechanisms for conveying availability or status information. The devices that people interact with know bits and pieces about how available they are for communications or other forms of interaction with others at any instant. People who are on the phone are less available to most others for the duration of the call, but may want to be interrupted by selected callers.

The location of a person on a mobile phone is information that may be relevant for determining whether that person is available for a certain type of event. For example, someone traveling far away from home may not be available for physical interaction with their neighbors, but may be available to take a call. Similarly, someone near a particular restaurant at lunchtime is a potential consumer.

Presence-related information is routinely generated in many devices connected to various networks. For example, a person using a personal computer (PC) attached to a network may generate various presence state information. An “On-line” state indicates a user has logged onto a network, such as the Internet or a corporate intranet, while an “Off-line” state indicates no connection is currently active between the user and the presence engine. “Idle” status implies the user's system, although logged on, has not been active recently. Similarly, a person who acknowledges a calendar event in a PC or personal digital assistant (PDA) essentially signals limited availability to most others for some duration, while at the same time indicates that the person is active on that device.

In addition to dedicated devices providing their respective state information, computer presence systems run dedicated applications, which keep track of subscriber status by determining whether the subscriber is logged on or off, as well as monitoring the subscriber's participation in the service. Although this information is often coarse and uninformative, especially when a user is logged on but not actively participating, the information would be beneficial as one of the many types of state information that is monitored by an integrated presence system in relation to a particular user. Instant messaging systems provide an exemplary and pervasive computer presence system as part of their service. In an exemplary embodiment of the present invention, the state information of an instant messaging user can be automatically provided to an integrated presence system without requiring reconfiguration or modification of the instant messaging system. In particular, the integrated presence system emulates a participant in the instant messaging service and is configured to receive the normal state information updates of other participants in traditional fashion.

Prior to delving into the detailed aspects of the present invention, an exemplary integrated presence system capable of receiving state information from a variety of devices over multiple networks is described. Subsequently, details are provided on how to configure a computer presence system in the integrated presence system, such that the computer presence system can automatically provide state information to the integrated presence system.

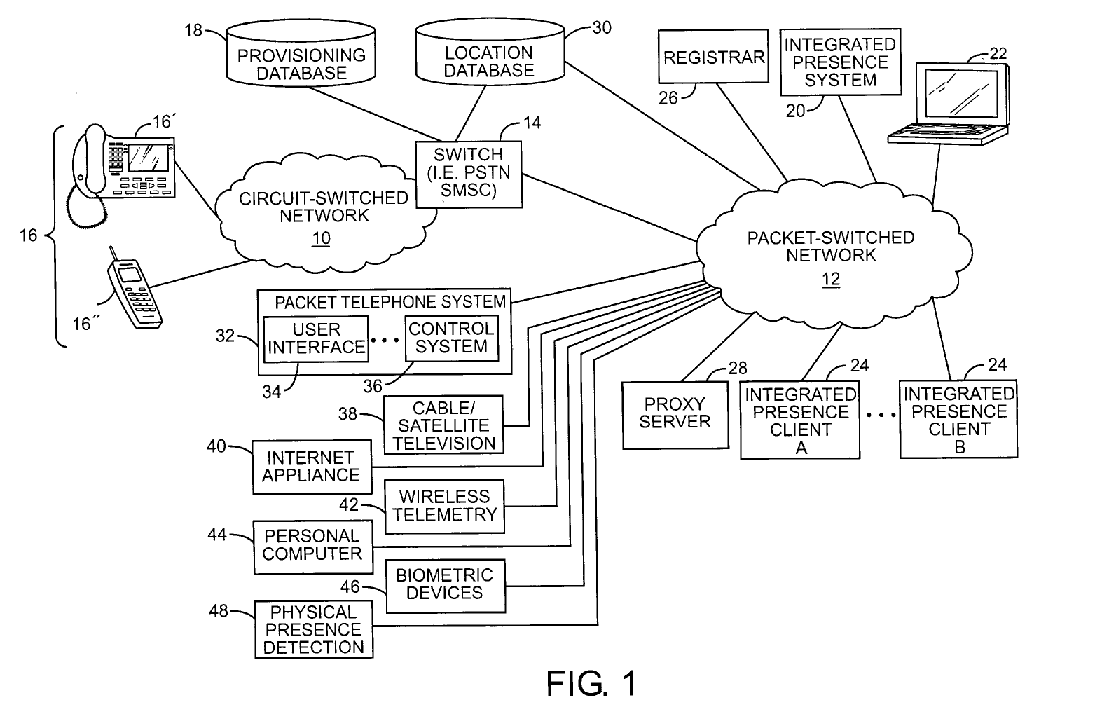

With reference to FIG. 1, a communication environment that is capable of automatically generating presence information from a plurality of sources is illustrated. The communication environment may include a circuit-switched network 10, such as the public switched telephone network (PSTN) or a cellular communication network, and a packet-switched network 12, such as the Internet, which supports packet-switched communications. The circuit-switched network 10 may include various types of switches 14 to facilitate circuit-switched communications for landline or wireless communications. The circuit-switched network 10 supports communications with various types of telephony devices 16, such as a traditional landline telephone 16′ or a mobile telephone 16″. In a wireless communication embodiment, the switches 14 cooperate with base stations (not shown), which facilitate wireless communications with mobile terminals, such as the mobile telephone 16″. Those skilled in the art will recognize the functionality of the switches 14 and other components in the circuit-switched network 10 to facilitate communications with the landline and wireless telephony devices 16.

The switch 14 is defined as being either an integrated device or multi-component system facilitating circuit-switched communication and including call server or call control functionality, which is traditionally provided in intelligent networks (IN), such as those implementing SS7 and the like. Typically, the switches 14 cooperate with a provisioning database 18, which provides information allowing a switch 14 to properly identify, locate, and provision the various telephony devices 16 in the circuit-switched network 10. An integrated presence system 20 located on the packet-switched network 12 is used to deliver state information, which is derived from user interaction with any number of sources. For example, the switch 14 may be configured to provide the state of the telephony device 16, its location, or a combination thereof, directly or indirectly to the integrated presence system 20.

The integrated presence system 20 may be configured by a user device, such as a PC 22, and operates to collect state information for various devices of various users, process the state information to derive presence information, and provide the presence information to integrated presence clients 24, automatically or in response to a request. As will be described below in further detail, the integrated presence system 20 is also capable of subscribing to a computer presence system (not shown in FIG. 1) to receive state information as if the integrated presence system 20 were a participant in a service provided by the computer presence system.

Each integrated presence client 24 directly or indirectly provides alerts to the associated user based on presence information associated with other users and derived from the integrated presence system 20. Preferably, the integrated presence client 24 subscribes to the integrated presence system 20 and identifies the users whose presence information is desired. The integrated presence system 20 will accept these subscriptions as well as register participating users and their associated devices. The integrated presence system 20 may also implement various presence delivery rules to allow users to control the dissemination of their presence information to subscribers. Notably, various profiles may be established to allow select groups of subscribers to obtain more presence information than other groups. Accordingly, each registered user may implement filters or rules to control dissemination of information to subscribers. In the converse, subscribers electing to receive the presence information of others may also establish profiles identifying the users whose presence information is desired and the types of presence information they wish to receive.

A registrar 26 may be provided on the packet-switched network 12 to maintain a relationship between the logical and the physical addresses of devices that directly or indirectly communicate with the integrated presence system 20. Such registration is typically required only when there is a change between the logical or user addresses and the physical addresses of a given device.

In one embodiment, the switch 14 is configured to provide state information corresponding to status, mode, location, or a combination thereof associated with a telephony device 16 to the integrated presence system 20. A proxy server 28 may be provided to act as a liaison between the switch 14 and the integrated presence system 20. As such, the switch 14 will provide presence information to the proxy server 28, which will represent the switch 14 to the integrated presence system 20 in traditional proxy fashion. Those skilled in the art will recognize that the proxy server 28 is optional and may prove beneficial with certain communication protocols.

The presence information provided to the integrated presence system 20 from the switch 14 will depend on the application and the type of communication environment. For example, the traditional landline telephone 16′ will not change location, typically providing location information only as a part of registration, and will dynamically provide a mechanism to determine state information relating to its operation. The switch 14 that serves the telephone 16′ can determine whether the phone is on-hook or off-hook, and thus determine whether the user is engaged in a telephone call. More sophisticated systems may be able to determine whether the party is on a conference call, on hold, and whether any settings on the phone indicate that the user is in or out of the office. Accordingly, the state information gathered by the switch 14 in association with the operation of telephone 16′ is used to create presence information to send to the integrated presence system 20 via the proxy server 28.

For mobile terminals, such as the mobile telephone 16″, the servicing mobility switching center (SMSC), which is represented by the switch 14, may gather all of the state information described above, as well as provide dynamic location information derived directly from the mobile terminal 16″ or from the circuit-switched network 10. Accordingly, the state information for mobile devices may be supplemented with location information, which provides the integrated presence system 20 the opportunity to distribute presence information to the various integrated presence clients 24 based on dynamic location, if so desired. The location information may be provided by the mobile telephone 16″, if equipped with location detection technology, such as that provided by the Global Positioning System (GPS), wherein the mobile telephone 16″ receives the GPS coordinates and may provide either the coordinates to the switch 14, which will determine the mobile telephone's location, or may process the GPS information to determine a location, which is then sent to the switch 14. Alternatively, triangulation techniques may be used to determine the mobile telephone's location, which may be stored in a location database 30 or like device. The location database 30 may be accessed via the switch 14 to obtain location information, or the location database 30 may be configured such that the integrated presence system 20 or an associated device may directly access it via the packet-switched network 12.

Packet-based telephony devices, such as packet telephone system 32, essentially emulate the operation of circuit-switched telephony devices 16 entirely over the packet-switched network 12. Thus, state information associated with a fixed or mobile packet telephone system 32 may be configured to automatically provide state information, and perhaps location information, to the integrated presence system 20 directly or indirectly via a proxy server 28. The packet telephone system 32 will include a user interface 34 and a control system 36. As those skilled in the art will recognize, the packet telephone system 32 may be integrated into a single device, or may be implemented in multiple devices in a client-server configuration. For the latter case, the proxy server 28 may be further configured to support various operational features of the packet telephone system 32.

The user interface 34 may include a microphone and speaker to facilitate voice communications, as well as various keypads and displays to allow user interaction in traditional fashion. The control system 36 will operate to support the user interface 34 and provide the requisite functionality to enable the packet telephone system 32 to facilitate communications with other devices on the packet-switched network 12 directly or indirectly via the proxy server 28. For the purposes of description, assume that the control system 36 is capable of gathering and providing state information for the packet telephone system 32. In wireless environments, a wireless packet-switched network (not shown) is necessary to facilitate communications with the packet-switched network 12.

In addition to telephony-based updates, an unlimited number of devices or systems with which users directly or indirectly interact may be modified to automatically provide state information. The devices and systems may include cable or satellite television systems 38, internet appliances 40, wireless telemetry devices 42, PCs 44, biometric devices 46, physical presence detection systems 48, and the like. For example, set-top boxes or receivers of cable or satellite systems 38 may be configured to provide state updates to a central location, which forwards the updates to the integrated presence system 20 in association with the user. These devices are normally on disparate networks and configured to communicate various types of information, such as billing information, to a central location. Preferably, a server at the central location will facilitate delivery of state information to the integrated presence system 20. The server may be configured to monitor the respective devices to determine state changes, or may simply receive state changes generated by the devices. With the proliferation of broadband Internet connectivity, particularly in cable networks, devices of this type could also be directly attached to the packet switched network 12 and provide state updates directly to the integrated presence system 20. Similarly, internet appliances 40, such as refrigerators, dishwashers, alarm systems and the like, can readily be configured to send state information relating to user interaction directly or indirectly to the integrated presence system 20.

Wireless telemetry devices 42 may monitor a user's interaction or location associated with a person or vehicle and provide state information to the integrated presence system 20. Similarly, biometric devices 46, which monitor or check biometric data of the user, and physical presence detection systems 48, which monitor physical presence, may provide state information to the integrated presence system 20. Any of the devices and systems may be connected directly or indirectly, via a gateway or the like, to the Internet. Further, entertainment systems, such as home theater systems, gaming consoles, televisions, and the like can sense user activity and provide state updates to the integrated presence system 20.

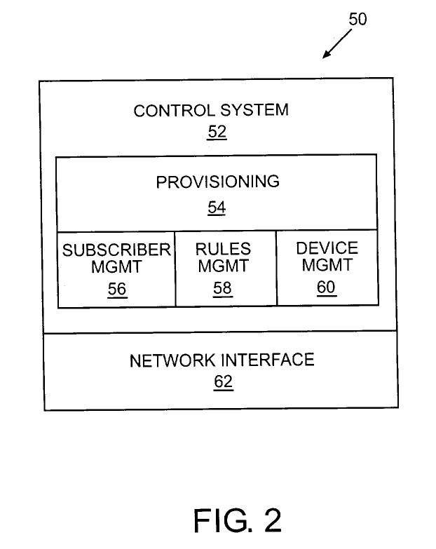

With reference to FIG. 2, the integrated presence system 20 may be implemented in one or more cooperating presence servers 50. A logical breakdown of one embodiment of the presence server 50 is illustrated. A presence server 50 may include a control system 52 adapted to implement provisioning logic 54, subscriber management logic 56, rules management logic 58, and device management logic 60. The device management logic 60 facilitates and controls interaction with the various devices, which are configured to provide state information to the presence server 50 based on user interaction. The subscriber management logic 56 facilitates and controls interaction with the integrated presence clients 24 associated with subscribers.

Accordingly, the integrated presence clients 24 will subscribe to the presence server 50 to receive status updates for one or more users via the subscriber management logic 56. Based on the subscription, the presence server 50 will receive state information from the various devices, evaluate the state information to generate presence information using rules in the rules management logic 58, and deliver the presence information to the subscribing integrated presence client 24. The device management logic 60 will control interaction with the various devices providing state information. Such control may include configuring the device to provide the state information in a specified manner and format. The provisioning logic 54 facilitates provisioning of the subscriber management logic 56, rules management logic 58, and device management logic 60. Provisioning may include establishing a profile for the user providing presence information. The profile will typically identify devices and their respective states to monitor, provide rules for evaluating the state information to generate the presence information, and identify individuals, systems, or applications authorized to receive the information. The control system 52 is also associated with a network interface 62 for facilitating communications over the packet-switched network 12.

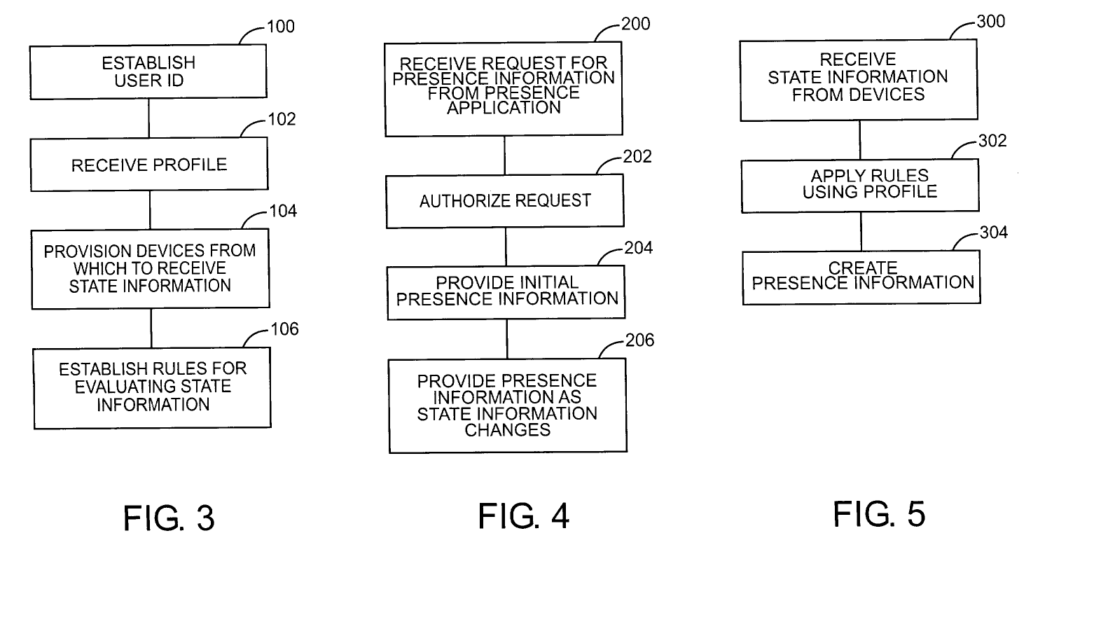

An exemplary process for initializing the integrated presence system 20 to disseminate user information is outlined in FIG. 3. Initially, the user must establish an identification for the presence service provided by the integrated presence system 20 (step 100). The presence service will then receive a profile for the user (step 102). Based on the profile, the presence service is provisioned to receive state information from the devices (sources) (step 104). Preferably, the device management logic 60 is configured to receive the state information from the provisioned devices. To configure the devices, users may have to interact directly with the devices, or some server or switch to which they are attached, in order to configure the devices to start sending status information to a certain entity associated with the integrated presence system 20 or directly to the integrated presence system 20. An exemplary model may actually be for the devices to subscribe to supply information on behalf of a user, who will authorize the devices to provide the status information. Next, the rules for evaluating the state information are established based on the profile (step 106). At this point, the rules management logic 58 and device management logic 60 are configured for a given user. The rules typically define how to evaluate the state information and deliver the resultant presence information. A user may use the profile to establish rules to control how they should be contacted based on the state of one or more associated devices.

Those skilled in the art will recognize limitless variations in profile and rule constructions for evaluating state information and generating presence information to send to subscribing integrated presence clients 24. Further, any combination of current and past device state information may be used to determine the presence information. Preferably, the presence information is automatically updated, if necessary, when state changes are detected. Depending on the presence rules, a state change from a given device may or may not impact the presence information. If the presence information does not change, then there may not be a need to update the subscribing integrated presence clients 24.

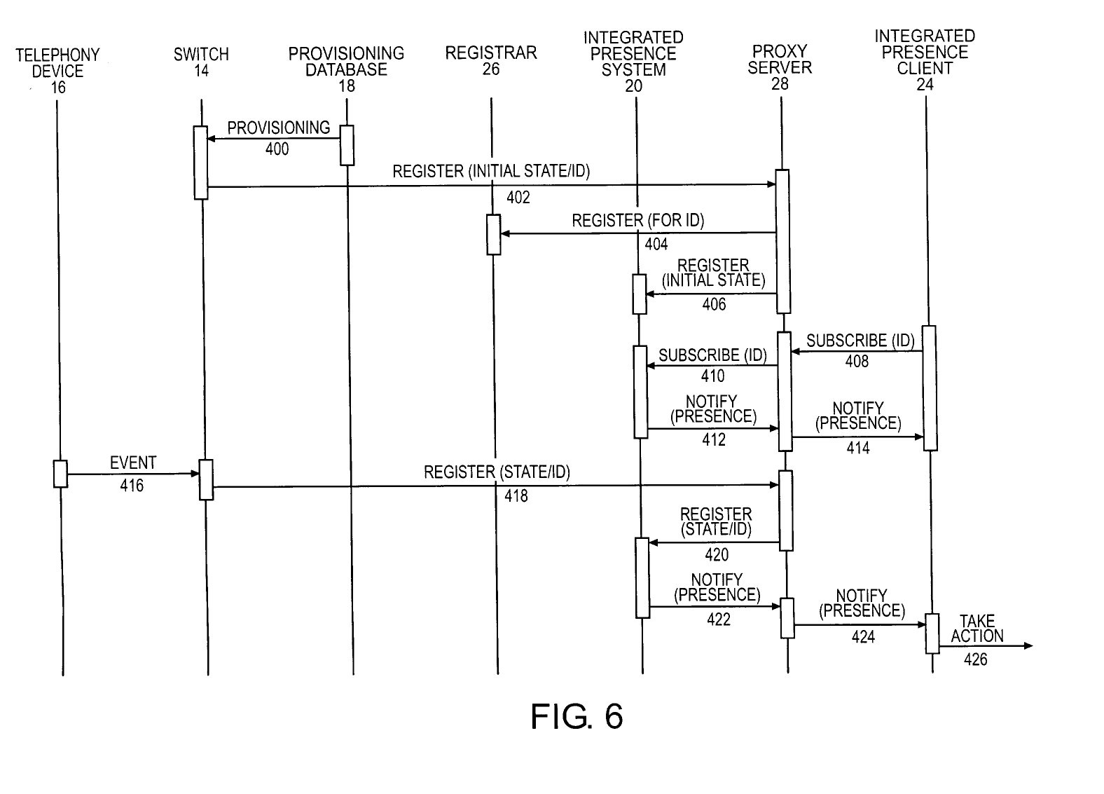

FIG. 4 provides an exemplary process for subscribing to presence updates for a user through the presence service. Initially, a subscriber, via an integrated presence client 24, will send a request to subscribe to the presence service. The subscription management logic 56 will receive the request for presence information from the integrated presence client 24 (step 200). The presence service will authorize the request (step 202), and, if authorized, provide initial presence information to the subscribing integrated presence client 24 (step 204). The initial presence information may be default presence information or that based on current states of the devices as evaluated by the rules. Once subscribed, the presence service will provide presence information to the integrated presence client 24 as state information from the devices change in a manner warranting a presence update (step 206).

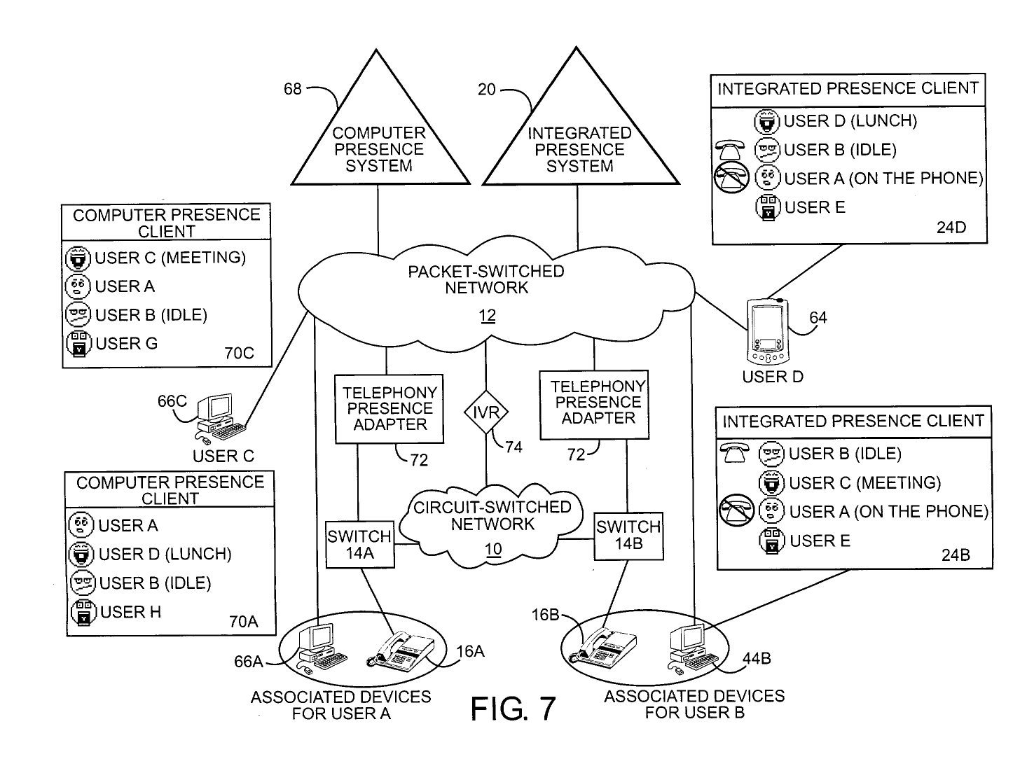

FIG. 5 illustrates an exemplary process for evaluating state information from the provisioned devices. The process continuously receives state information from all provisioned devices (step 300) and applies the rules for the user based on the user profile (step 302). Notably, the integrated presence client 24 or subscriber associated therewith can also provide a profile to configure or otherwise filter the types of presence information requested. Finally, the rules management logic 58 will evaluate the state changes and create presence information, if necessary, to send to the subscribing integrated presence client 24 (step 304).

Accordingly, the present invention automatically receives state information from interactions with devices and evaluates the state information with a rules-based presence system that takes into account relatively static preferences supplied directly by the user wishing to project an indication of presence along with optional positional data associated with the devices. Those skilled in the art will recognize that manually provided state information may be used by the rules management logic 58 in combination with those initiated from naturally occurring interactions.

Although many communication protocols may be used to facilitate communications, including delivery of state and presence information between the various devices, the Session Initiation Protocol (SIP) or the SIP for Instant Messaging and Presence Leveraging Extensions (SIMPLE) protocol is implemented in one embodiment of the present invention. The specification for SIP is provided in the Internet Engineering Task Force's RFC 3261: Session Initiation Protocol, which is incorporated herein by reference in its entirety.

In general, a SIP proxy, such as may be provided by the proxy server 28, may facilitate media sessions between any number of endpoints, which represent the devices communicating with each other. These endpoints may support any one or combination of data, audio, and voice media sessions, depending on the configuration of the respective endpoints. In addition to traditional SIP endpoints, endpoints for the present invention may take the form of the switch 14, the registrar 26, the integrated presence system 20, the device running the integrated presence client 24, and the like.

A SIP endpoint is generally capable of running an application, which is generally referred to as a user agent (UA), and is capable of facilitating media sessions using SIP. User agents register their ability to establish sessions with a SIP proxy, such as proxy server 28, by sending REGISTER messages to the SIP proxy. The REGISTER message informs the SIP proxy of the SIP universal resource locator (URL) that identifies the user agent to the SIP network. The REGISTER message also contains information about how to reach specific user agents over the SIP network, by providing the Internet Protocol (IP) address and port that the user agent will use for SIP sessions. A SUBSCRIBE message may be used to subscribe to an application or service provided by a SIP endpoint. Further, NOTIFY messages may be used to provide information between SIP endpoints in response to various actions or messages, including REGISTER and SUBSCRIBE messages.

When a user agent wants to establish a session with another user agent, the user agent initiating the session will send an INVITE message to the SIP proxy and specify the targeted user agent in the TO header of the INVITE message. Identification of the user agent takes the form of a SIP URL. In its simplest form, the URL is represented by a number or “<username>@<domain>,” such as “janedoe@nortelnetworks.com.” The SIP proxy will use the SIP URL in the TO header of the message to determine if the targeted user agent is registered with the SIP proxy. Generally, the user name is unique within the name space of the specified domain.

If the targeted user agent has registered with the SIP proxy, the SIP proxy will forward the INVITE message directly to the targeted user agent. The targeted user agent will respond with a 200 OK message, and a session between the respective user agents will be established as per the message exchange required in the SIP specification. Media capabilities are passed between the two user agents of the respective endpoints as parameters embedded within the session setup messages, such as the INVITE, 200 OK, and acknowledgement (ACK) messages. The media capabilities are typically described using the Session Description Protocol (SDP). Once respective endpoints are in an active session with each other and have determined each other's capabilities, the specified media content may be exchanged during an appropriate media session.

The following example illustrates detailed message flows related to telephony devices, which are in one particular class of devices that can provide state information. Other classes of devices, including but not limited to those previously discussed, may have their own unique message flows to achieve similar results. Those skilled in the art will recognize there are many implementation methods possible for associating devices with the integrated presence system 20. This SIP-based example provides a relatively simplified explanation of relevant message flows.

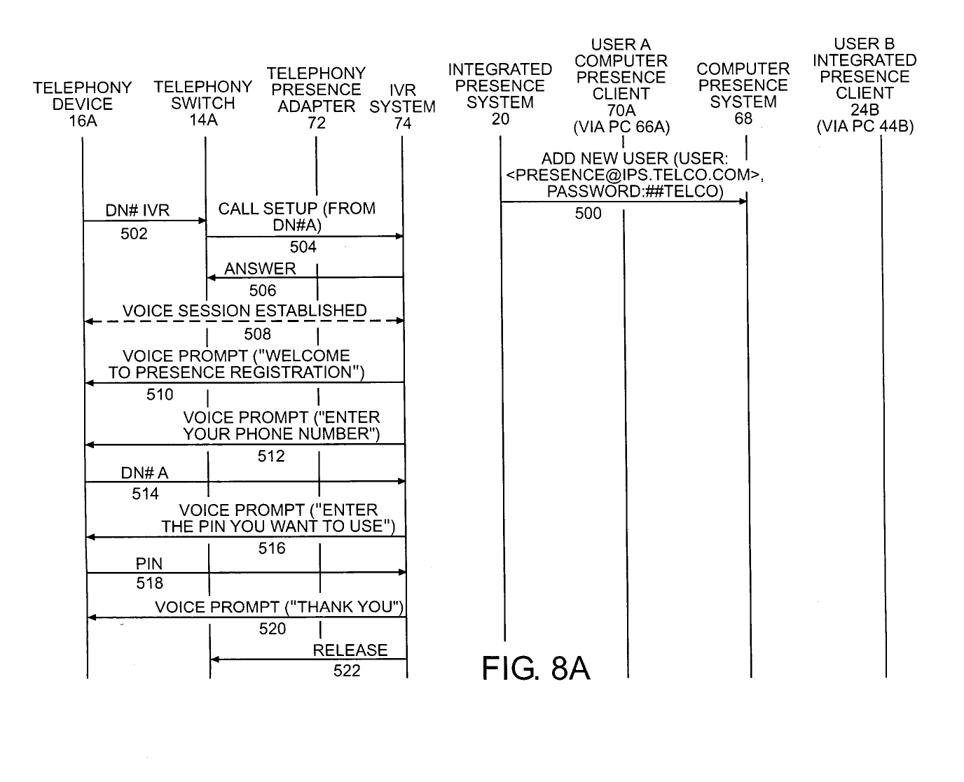

An exemplary message flow for providing state information relating to a telephony device 16 on the circuit-switched network 10 is illustrated in FIG. 6. Although the SIP protocol is used for illustration, those skilled in the art will recognize the general functionality of the described messages and their applicability to other protocols. Further, the switch 14 is preferably configured to monitor states resulting from user interactions and provide corresponding state information to the integrated presence system 20. For example, the interaction could be the user participating in a call or selecting a mode of operation, such as ring, meeting (off or vibrate), or actually participating in a call.

The flow begins when a user initially requests activation of the telephony device 16 through a local exchange carrier or like entity, which controls access and communications for the telephony device 16. Typically, the telephony device 16 is provisioned when provisioning information is sent from the provisioning database 18 to the switch 14 (step 400). The traditional provisioning information is supplemented with information indicating whether the user of telephony device 16 wishes to subscribe to the presence service provided by the integrated presence system 20. Accordingly, the switch 14 will receive the provisioning information from the provisioning database 18 and provision the telephony device 16, as well as store information that correlates the relationship between the telephony device 16 and a presence ID, which is used by the integrated presence system 20 for determining the state of the telephony device 16. The telephony device 16 is typically identified on the circuit-switched network 10 using a directory number, caller identification, or similar designation. Alternatively, a user may be able to dynamically provision a device from the device, without requiring the network operator to take action.

Once the provisioning of telephony device 16 is complete, the switch 14 will send a REGISTER message to the proxy server 28 (step 402). Preferably, the switch 14 registers as a user agent, and the proxy server 28 acts as a SIP proxy server. The REGISTER message effectively registers the ability of the switch 14 to provide presence information with the SIP proxy 28. In particular, the REGISTER message informs the proxy server 28 of the SIP URL that identifies the user agent of the switch 14 to the (SIP) packet-switched network 12. The REGISTER message may also contain information about how to reach the user agent over the packet-switched network 12, typically by providing the Internet Protocol (IP) address and port that the user agent will use for SIP sessions. Preferably, the REGISTER message will also include an initial state of the telephony device 16 and identification indicia for the telephony device 16. The identification indicia in a SIP environment is preferably a SIP ID, which is the logical address associated with the telephony device 16 as represented on the packet-switched network 12.

In response to this initial REGISTER message, the proxy server 28 will send a like REGISTER message to the registrar 26 to register the telephony device 16 with the registrar 26 (step 404). Further, the proxy server 28 may also forward the REGISTER message to the integrated presence system 20 (step 406). At this point, the integrated presence system 20 has registered the telephony device 16 and has associated an initial state with the telephony device 16. All other devices used to determine presence information of the user will register in the same or similar fashion.

The integrated presence system 20 consolidates and/or transforms device data into the state associated with a logical or user identification and provides relevant state information to the integrated presence client 24 (step not shown). Subsequently, the integrated presence client 24 will subscribe to the presence service provided by the integrated presence system 20 to receive presence state information based on state changes associated with the various devices of the user. Accordingly, the integrated presence client 24 will send a SUBSCRIBE message, which includes identification information (SIP ID) of the user or telephony device 16, to the proxy server 28 (step 408), which will forward the SUBSCRIBE message to the integrated presence system 20 (step 410). In response, the integrated presence system 20 will use the SIP ID provided in the SUBSCRIBE message to identify the user or devices for which presence information is requested. Once the integrated presence system 20 has evaluated the state of the telephony device 16, a NOTIFY message, including presence information for the user of the telephony device 16, is sent to the proxy server 28 (step 412), which forwards the NOTIFY message to the integrated presence client 24 (step 414). At this point, the integrated presence client 24 has subscribed to the presence service 20 for the user and has received the initial presence information for the user, and perhaps the state of the telephony device 16 and other devices, if so provisioned. Thus, the integrated presence client 24 may react as necessary in response to receiving the presence information for the user and awaits state change notifications for the user.

Assume that the telephony device 16 changes state, such as being placed on-hook, going off-hook, initiating a hold function, going out of service, initiating a service activation, changing modes, or the like. In essence, any change of state may trigger an event, which is sent to the switch 14 in traditional fashion (step 416). In addition to normal processing of the event, the switch 14 will recognize that the telephony device 16 has been provisioned to alert the presence service of state changes, and will send a REGISTER message identifying the telephony device 16 (preferably using the SIP ID) and including the current state to the proxy server 28 (step 418), which represents the integrated presence system 20 to the switch 14. The proxy server 28 will then send a REGISTER message to register the new state in association with the identified telephony device 16 with the integrated presence system 20 (step 420). The integrated presence system 20 will then process the state information to create the presence information for the user and send a NOTIFY message, if necessary, to the proxy server 28 to provide the updated presence information (step 422). The proxy server 28 will forward the NOTIFY message, which includes the presence information, to the integrated presence client 24 (step 424), which can then take appropriate action based on the state information (step 426). As noted above, the state information may be associated with location information in an appropriately configured wireless communication system.

Those skilled in the art will recognize that the use of REGISTER messages is only one implementation. In general, the switch 14 or some other device that provides autonomous state change information can use a REGISTER message or some other undefined message to notify the presence service. If the integrated presence system 20 subscribes to the information on the switch 14, which changes the role of the switch 14 to that of a presence user agent, it would allow the use of NOTIFY messages to communicate the presence data to the integrated presence system 20.

The switch 14 may be configured to provide a table that correlates the identification of the telephony device 16 on the circuit-switched network 10 with a presence identity, which is preferably a SIP address or URL. Using this table, the switch 14 can identify state changes for the telephony device 16, process the changes based on the rules management logic 58, and send updated state information indirectly or directly to the integrated presence system 20. For example, assume that a user has subscribed to an automatic presence service from a cellular communication operator. Part of the service subscription process will provision a presence address and correlate it with a registered mobile telephone 16″, based upon the mobile identification number, a SIM card identification, the telephone number, or like designation.

Whenever the user's mobile telephone 16″ is on and in reach of the mobile network, the home location register (HLR) is made aware of this fact as part of the normal course of cellular telephone operation. The HLR can register on-line status on behalf of the user's presence identification based on this information. As noted, the state information may include location identification in addition to traditional state information. Those skilled in the art will recognize the application of the present invention to both traditional time division multiplexing (TDM) switching systems and more recent innovations, such as IP public branch exchanges, or telephony clients, such as SIP user agents, H.323 endpoints, Microsoft NetMeeting, or real-time communication clients. Network resources, such as SIP proxies or H.323 gatekeepers, may also apply this technology if they retain call status information on the endpoints or user agents they manage.

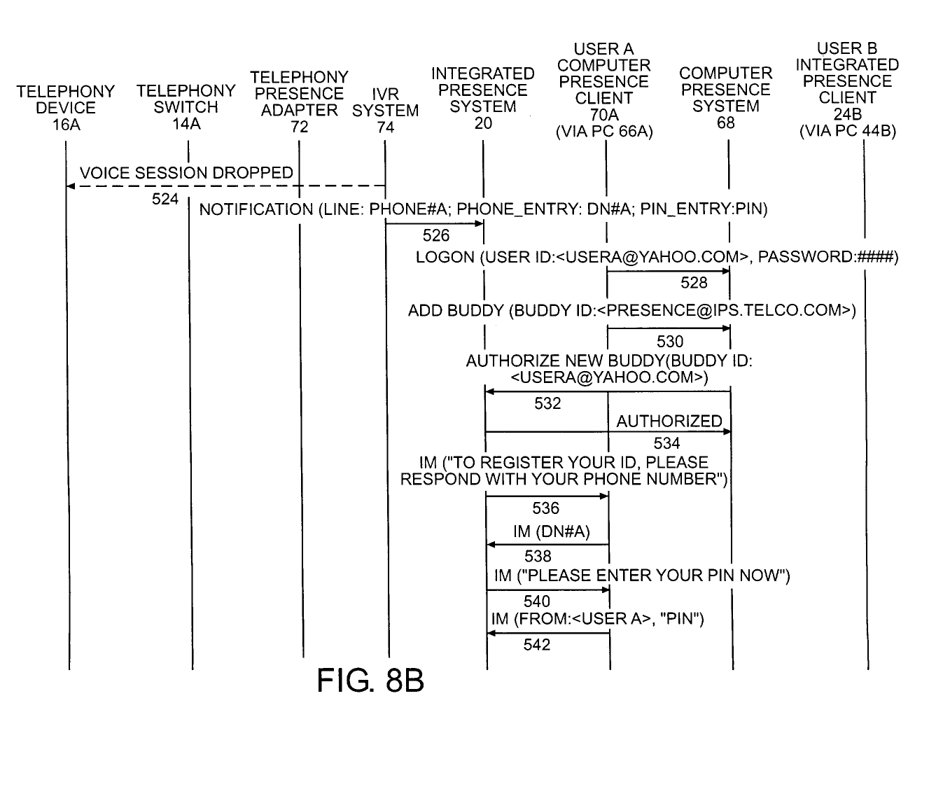

Turning now to FIG. 7, a communication environment according to one embodiment of the present invention is illustrated. As depicted, there are four users, users A, B, C, and D, associated with different devices. User A is associated with two devices, a PC 66A and a telephony device 16A. User B is associated with a telephony device 16B and a PC 44B. User C is associated with a PC 66C, while user D is associated with a PDA 64. In general, telephony device 16A of user A can initiate and receive calls via telephony switch 14A, which is coupled to the circuit-switched network 10, as well as being capable of providing state information for telephony device 16A to the integrated presence system 20. Those skilled in the art will recognize that the telephony switch 14A may take many forms and be directly or indirectly coupled to the packet switched network 12 instead of the circuit-switched network 10. The state information can be provided directly to the integrated presence system 20 or via a telephony presence adapter 72, which may be implemented by translating intelligent network triggers indicative of the state of telephony device 16A to a format capable of being processed by the integrated presence system 20. Other methods to extract user telephony presence information are possible. Similarly, telephony device 16B for user B is supported by telephony switch 14B, which directly or indirectly via telephony presence adapter 72 provides state information to the integrated presence system 20. Additionally, PDA 64 may be adapted to provide state information to the integrated presence system 20 via a wireless network (not shown). Notably, PC 44B and PDA 64 also provide integrated presence clients, 24B and 24D, respectively. The integrated presence clients 24B and 24D will receive presence information provided by the integrated presence system 20 as described above.

In addition to the integrated presence system 20, a computer presence system 68, such as that provided in an instant messaging application, facilitates a computer presence application on each of PCs 66A and 66C for users A and C, respectively. Thus, PCs 66A and 66C provide computer presence clients 70A and 70C, respectively. In essence, the computer presence system 68 facilitates an application in which users A and C participate. Based on such participation, the computer presence system 68 will provide information to PCs 66A and 66C pertaining to whether users A and C are logged in to the application and their relative activity in the application, and provide presence information based thereon to the respective computer presence clients 70A and 70C. Again, this limited state information is based solely on the interaction of user A and user C with their PCs 66A and 66C, respectively. The present invention allows the state information for the computer presence system 68 to be readily sent to the integrated presence system 20 through the normal operation of the computer presence application of computer presence system 68 without modification or requiring special configuration.

In traditional parlance, users A and C, who are subscribers to the computer presence system 68, are often referred to as “buddies,” and the respective computer presence clients 70A and 70C subscribe to the presence application provided by the computer presence system 68 to allow users A and C to communicate with their buddies, as well as keep track of the availability of their buddies to participate. Thus, users subscribing to the computer presence application will add buddies to their list of desired users with which to communicate and whose presence they wish to track. Normally, a user will request the addition of a buddy to the list, and the computer presence system 68 will obtain permission of the user to be added to the other user's buddy list. Once requested and authorized, the buddies may communicate with each other and track their respective presence information via the computer presence system 68. The present invention essentially allows the integrated presence system 20 to emulate a buddy and allow a user to add the integrated presence system 20 to her buddy list, such that the integrated presence system 20 will receive the normal state information provided by the computer presence system 68 through the normal operation of the computer presence application to which the user and integrated presence system 20 now subscribe.

Given the importance of only providing presence information to authorized users and obtaining state information after receiving permission, the present invention provides a unique way for users to cause their state information in the computer presence application to be provided to the integrated presence system 20, and therefore allow the integrated presence system 20 to use the state information from the computer presence system 68 in addition to any other state information to provide a better picture of availability than was previously available.

In the preferred embodiment, an integrated voice response (IVR) system 74 is provided in association with the circuit-switched network 10 or other network supporting a voice call, such that a user may call in to the IVR system 74 to provide sufficient information to configure the integrated presence system 20 to interact with the computer presence system 68 as described. In addition to providing configuration information, the process also allows the integrated presence system 20 to authenticate the user and validate the configuration. Thus, the IVR system 74 is configured to interact with the integrated presence system 20 via the packet-switched network 12. The integrated presence clients 24B, 24D and the computer presence clients 70A, 70C provide exemplary illustrations, including icons and text, for indicating the general presence or availability of the respective users.

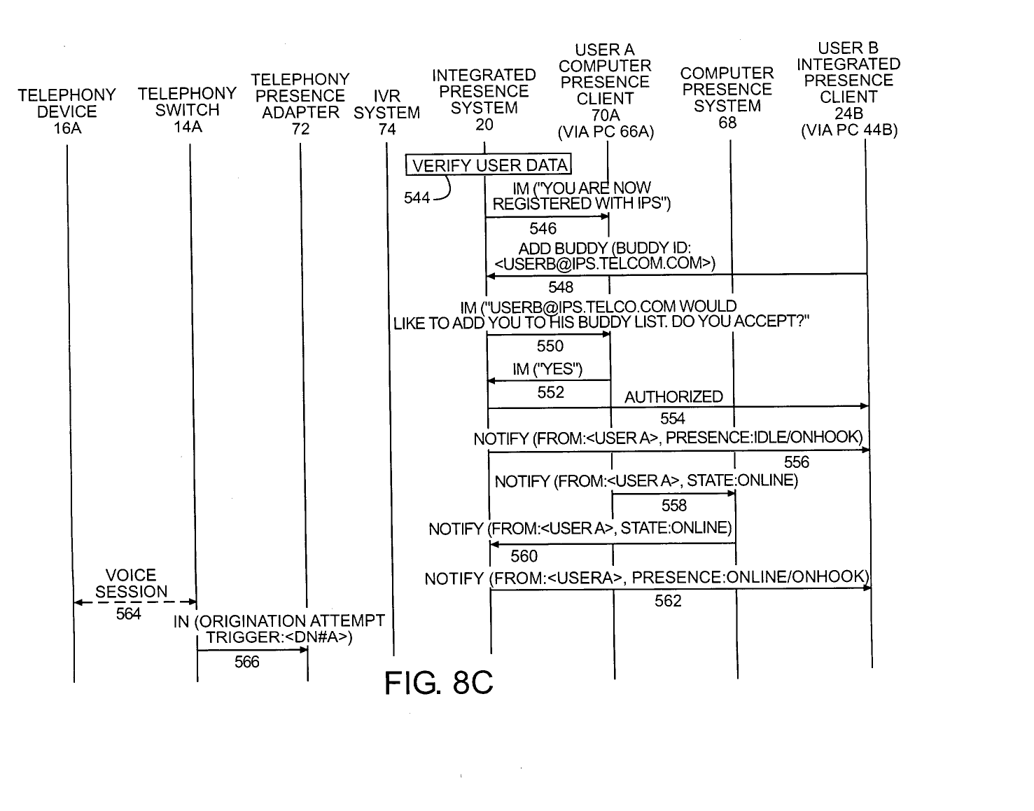

The call flow diagrams of FIGS. 8A-8C provide a detailed call flow for allowing user A to effect the delivery of state information from the computer presence system 68 to the integrated presence system 20, and subsequently, provide exemplary scenarios where state information is provided to the integrated presence system 20 from the computer presence system 68 based on interactions of user A with PC 66A as well as providing state information based on user A's interaction with telephony device 16A. Prior to describing the call flow, a general overview of the process is provided such that each of the call flow steps is provided sufficient context.

Initially, assume user A wants to add state information generated in association with a computer presence system 68 to the integrated presence system 20. Initially, user A will use telephony device 16A to dial a special number or code, such as *23, to establish a voice session, such as a telephony call, from telephony device 16A to the IVR system 74. The IVR system 74 will make note of the caller line identification (CLI) or other identification for the telephony device 16A or line supporting it to identify the directory number associated with the telephony device 16A. The IVR system 74, through a series of audio prompts, will confirm user A's telephone number and ask user A to select a personal identification number (PIN), which will be sent to the integrated presence server 20 along with the directory number or other identification indicia. User A will then log in to her computer presence application, which may be an instant messaging service or application, via her computer presence client 70A. Using the computer presence application's normal processes, user A will add a buddy to her buddy list. Importantly, the buddy being added to the buddy list is the integrated presence system 20, and thus, the name of the buddy corresponds to an alias for the integrated presence system 20. For example, the buddy may be called or be associated with presence@ips.telco.com. The integrated presence system 20 or administrators therefor will register this name with the computer presence application provided by the computer presence system 68, and other popular computer presence services. The integrated presence system 20 will emulate a computer presence client when interacting with the computer presence system 68.

The integrated presence system 20 will start a session, such as an instant messaging session, with user A's computer presence client 70A. The integrated presence system 20 will exchange messages with user A via the computer presence application to ask for user A's directory number and PIN provided to the IVR system 74. If the PIN corresponds to that entered via the IVR system 74, the integrated presence system 20 will integrate the state information provided by the computer presence system 68 for PC 66A with any other state information being collected by the integrated presence system 20 for user A. In this example, the presence information provided to other subscribers for user A can be based on the status of telephony device 16A, as well as the status of PC 66A, and made available via the computer presence application via the computer presence system 68. As an alternative to using the IVR system 74 for initial setup, the computer presence system 68 can be modified to provide a proprietary interface with user A via PC 66A for configuration and authentication. In order to give control to user A as to which other users of the integrated presence system 20 can get access to her integrated presence information 20, a user of the integrated presence system 20 such as user B who sends a request to add user A to his buddy list gets his request turned into an instant message by the integrated presence system 20 and sent to user A's computer presence client 70A asking for permission to add user B. In addition to or instead of sending this message, user A can access a web site linked to the integrated presence system 20, log on with the authentication information collected earlier, and manage her current buddy list by accepting new requests or deleting users no longer desired.

Turning now to FIGS. 8A-8D, the integrated presence system 20 sends a message to the computer presence system 68 to add itself as a new user to the computer presence system 68 (step 500). The new user is the integrated presence system 20, and has a user ID of presence@ips.telco.com, which becomes a public user ID that all users can easily learn about from a variety of sources. At this point, the integrated presence system 20 is registered as a user, and thus a potential buddy for other subscribers to the computer presence application provided by the computer presence system 68. This registration takes place once, no matter how many users of the computer presence system 68 want to interwork with the integrated presence system 20.

To initiate the process for providing state information from the computer presence system 68 to the integrated presence system 20, user A will pick up telephony device 16A and dial the directory number for the IVR system 74 (step 502). Telephony switch 14A will receive the directory number for the IVR system 74 and send a call setup message to the IVR system 74 including the directory number for telephony device 16A and any other line or telephony device identification indicia (step 504). The IVR system 74 will respond by sending an answer message to telephony switch 14A (step 506), which will take the necessary steps to establish a voice session between telephony device 16A and the IVR system 74 (step 508).

The IVR system 74 will provide a voice prompt to user A, such as, “Welcome to presence registration,” followed by a voice prompt to, “Enter your phone number,” (steps 510 and 512). In response, user A will either speak or enter the directory number for telephony device 16A (step 514), which will trigger the IVR system 74 to provide a voice prompt to enter a PIN, such as, “Enter the PIN you want to use,” (step 516). User A will oblige by entering the desired PIN (step 518), which is received by the IVR system 74. The IVR system 74 may then send a final voice prompt, such as, “Thank you,” to user A signifying the end of the interaction (step 520). The IVR system 74 will then send a release message to telephony switch 14A (step 522), which will drop the voice session (step 524). The IVR system 74 will then send a notification message to the integrated presence system 20 providing the directory number for telephony device 16A, the line number for telephony device 16A, or other telephony identification indicia, along with the PIN provided by user A (step 526). At this point, the integrated presence system 20 will have sufficient information to authenticate user A via the computer presence system 68.

Next, user A will access the computer presence application by logging on to the application via user A's computer presence client 70A by entering her user ID and password (step 528). Then, user A will take the necessary steps to add a buddy, which corresponds to the integrated presence system 20. As such, an ADD BUDDY message is sent to the computer presence system 68, wherein the message specifies the buddy ID corresponding to the integrated presence system 20 (presence@ips.telco.com) (step 530). In response, the computer presence system 68 will take the normal steps to check with the buddy to see if the buddy authorizes user A's request. Thus, an AUTHORIZE NEW BUDDY request message is sent from the computer presence system 68 to the buddy ID of the integrated presence system 20, which is emulating a subscriber to the computer presence system 68, just like user A (step 532). The AUTHORIZE NEW BUDDY message will include user A's user ID for the computer presence system 68. The integrated presence system 20 will send a message back to the computer presence system 68 indicating that the new buddy is authorized (step 534). The integrated presence system 20 will by default authorize all new computer presence user IDs. However if the computer presence user ID doesn't authenticate itself successfully in a reasonable time with the process described in steps 536-546, the computer presence user ID will be dropped from the authorized list.

Acting as a subscriber to the computer presence system 68, the integrated presence system 20 will then send a message, such as an instant message, to user A's computer presence client 70A to initiate registration with the integrated presence system 20 (step 536). For example, the instant message may include, “To register your ID, please respond with your phone number.” As such, user A, via the computer presence client 70A, will initiate an instant message back identifying the directory number for telephony device 16A (step 538). The integrated presence system 20 will then initiate an instant message requesting user A to, “Please enter your PIN now,” (step 540). In response, user A will send an instant message to the integrated presence system 20 with the PIN entered via the IVR system 74 (step 542). The integrated presence system 20 will then verify the data provided by user A by comparing the directory number and PIN entered via instant messaging with that provided through the IVR system 74 (step 544).

Assuming the data is verified, the integrated presence system 20 will send an instant message confirming that user A has successfully registered with the integrated presence system 20 (step 546), such that the integrated presence system 20 will receive the state information normally provided to user A's buddies listed on user A's buddy list in traditional fashion. The instant message sent to user A's computer presence client 70A may simply be an instant message stating, “You are now registered with IPS.” The steps illustrated herein are merely exemplary, and various other options are possible. In particular, the computer presence client 70A for User A may send an instant message to the integrated presence system 68.

Next, user B is authorized to provide and receive presence information. Initially, user B's integrated presence client 24B will send an ADD BUDDY message including a buddy ID for user B to the integrated presence system 20 (step 548). In response, the integrated presence system 20 will send an instant message to user A's computer presence client 70A, such as “User B at ips.telco.com would like to add you to his buddy list. Do you accept?” (step 550). User A through user A's computer presence client 70A may respond with a “Yes” instant message (step 552), which will trigger the integrated presence system 20 to authorize user B and send a like message to user B's integrated presence client 24B (step 554). Initially, the integrated presence system 20 may send a NOTIFY message providing presence information for user A to user B's integrated presence client 24B (step 556). Assume that initially user A is not online (idle) and is not participating in a telephone call via telephony device 16A (onhook). Next, assume that user A starts to reuse her computer after some period of inactivity. Her computer presence status will now change from IDLE to ONLINE. As a result, user A's computer presence client 70A will send a NOTIFY message to the computer presence system 68 indicating that user A is now online (step 558). As such, the computer presence system 68 will send a NOTIFY message indicating that user A is online to the integrated presence system 20 (step 560). The integrated presence system 20 will process the information and send presence information relating to user A in a NOTIFY message to user B's integrated presence client 24B (step 562). The presence information will indicate that user A is online and telephony device 16A is on hook.

In this example, the state information from the computer presence system 68 is indicia indicative of user A participating in the computer presence application provided by the computer presence system 68, and the presence information may be the state information provided, or may be a result of that state information processed with other available state information. Assume next that a voice session is established involving telephony device 16A and facilitated via telephony switch 14A (step 564). Telephony switch 14A may send an intelligent network (IN) origination attempt trigger to the telephony presence adapter 72 (step 566). The origination attempt trigger will identify the directory number for telephony device 16A, and as such, the telephony presence adapter 72 will send a NOTIFY message to the integrated presence system 20 to provide state information associated with telephony device 16A (step 568). The integrated presence system 20 will process the state information in relation to other state information, such as that indicative of user A being online, and deliver presence information to user B's integrated presence client 24B (step 570). Next, assume that the voice session is ended by telephony device 16A going on hook (step 572), wherein telephony switch 14A will send an IN call termination trigger including the directory number for telephony device 16A to the telephony presence adapter 72 (step 574). The telephony presence adapter 72 will send a NOTIFY message indicating telephony device 16A went on hook (state information) to the integrated presence system 20 (step 576). The integrated presence system 20 will process the state information, along with any other available state information pertaining to user A, and send the updated presence information to user B's integrated presence client 24B (step 578). The updated presence information in this case may indicate that user A is still online and available for receiving a telephone call.

As seen from the above, users can securely interact with the integrated presence system 20 via the IVR system 74 to provide authentication information, which is subsequently used by the computer presence system 68 to authorize the delivery of state information in a normal fashion to the integrated presence system 20, as if it were another subscriber to the computer presence system 68. The user can then interact via a subscribing client to the computer presence system 68, add the integrated presence system 20 as a buddy, and have her computer-based state information sent to the integrated presence system 20 as if it were any other buddy. The integrated presence system 20 can then process the state information, along with any other state information for the user, and provide presence information based thereon to subscribers to the integrated presence system 20.

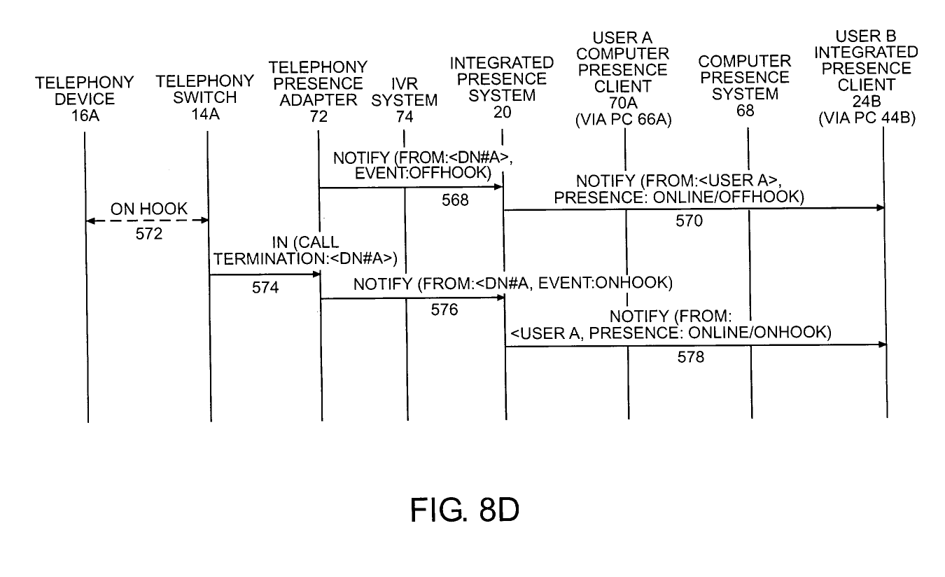

Turning now to FIG. 9, a block representation of a switch 14 is illustrated. The switch 14 is represented generically and is intended to cover the logical functionality of land-based and mobile switching systems, which include all control for call server-based functions. These switches 14 may be implemented in a variety of ways using different equipment types, such as Nortel Networks Limited's DMS-100 local switching system. The switch 14 typically includes a switching fabric module 76, a computing module 78 including storage software 80, a subscriber/base station interface 82, a network interface 84, and an operations/administration and maintenance (OA & M) module 86. The telephony presence adaptor 72 may be provided to facilitate communications with the integrated presence system 20 and other devices on the packet-switched network 12. The switching fabric 76 may comprise logical and physical switches for interconnecting the subscriber/base station interface 82 with the remainder of the circuit-switched network 10 through the network interface 84. Depending on a landline or wireless embodiment, the subscriber/base station interface 82 will either directly support subscribers through subscriber lines or will support base stations, which facilitate wireless communications with mobile devices. As illustrated, the computing module 78 controls circuit-switched communications via the switching fabric 76 and is capable of providing traditional intelligent network monitoring and functions. Further, the computing module 78 may cooperate with the provisioning database 18 as described above. As noted, the functionality of the switch 14 may be provided in various levels of integration.

In operation, the software 80 of the computing module 78 is modified to recognize state changes associated with supported telephony devices 16 and to provide the state information via the telephony presence adaptor 72 either directly or indirectly to the integrated presence system 20 on the packet-switched network 12. As noted, the messages sent to the integrated presence system 20 will include identification of the associated telephony device 16, relative state information, and perhaps location information derived from a mobile telephone 16″ or from elsewhere in the system. Preferably, the computing module 78 will cooperate with the provisioning database 18 to store information indicating that the particular telephony device 16 is subscribing to the presence service and providing an address for sending state change messages directly or indirectly to the integrated presence system 20. The other devices providing state information are similarly configured to trigger delivery of state information upon recognizing the occurrence of an event caused by the natural interaction with the device.

Current presence technology standards and systems are provided for in references from the Internet Engineering Task Force (IETF). Presence technology protocol-related publications hereby incorporated by reference include: Day, M., Aggarwal, S. and Vincent, J., “Instant Messaging/Presence Protocol Requirements,” Request for Comment (RFC) 2779, February 2000; Day, M., Rosenberg, J. and Sugano, H., “A Model for Presence and Instant Messaging,” RFC 2778, February 2000; Rosenberg, J. and Schulzrinne, H., “SIP caller preferences and callee capabilities,” November 2000; Crocker, D. et al., “A Common Profile for Instant Messaging (CPIM),” (work in progress), February 2001.

Those skilled in the art will recognize improvements and modifications to the preferred embodiments of the present invention. All such improvements and modifications are considered within the scope of the concepts disclosed herein and the claims that follow.

What is claimed is:

1. A method for operating an integrated presence system to receive state information from a computer presence system comprising:
a) receiving a request to add an integrated presence system to a buddy list of a user associated with a first computer presence client;
b) sending authorization to add the integrated presence system to the buddy list;
c) receiving state information of the first computer presence client from a computer presence system; and
d) sending presence information based on the state information to an integrated presence system client, which subscribes to the integrated presence system to receive the presence information for the user.

2. The method of claim 1 further comprising creating the presence information based on the state information.

3. The method of claim 1 further comprising receiving additional state information from another device capable of providing the additional state information associated with the user and wherein the presence information is further based on the additional state information.

4. The method of claim 1 further comprising receiving additional state information from a plurality of devices capable of providing the additional state information associated with the user and wherein the presence information is further based on the additional state information.

5. The method of claim 1 further comprising subscribing the integrated presence system to the computer presence system as a second user.

6. The method of claim 1 wherein the computer presence system is an instant messaging system.

7. The method of claim 1 further comprising:
a) receiving first indicia from a source unaffiliated with the computer presence system;
b) receiving second indicia from the first computer presence client via the computer presence system; and
c) comparing the first and second indicia to authenticate the user and associate the source of the first indicia with first computer presence client, wherein the user must be authenticated to send the presence information.

8. The method of claim 7 further comprising sending a request for the second indicia to the first computer presence system client via the computer presence system.

9. The method of claim 7 wherein the source is an interactive voice response system capable of interacting with the user via a telephony device associated with the user and the first indicia includes user information provided by the user during a voice session with the interactive voice response system via the telephony device.

10. The method of claim 9 wherein the second indicia includes the user information provided by the user via the first computer presence client.

11. The method of claim 10 wherein first and second indicia include a directory number associated with the telephony device

12. The method of claim 11 wherein the user information includes a password provided by the user.

13. An integrated presence system capable of receiving state information from a computer presence system comprising:
a) an interface; and
b) a control system associated with the interface and adapted to:
i) receive a request to add an integrated presence system to a buddy list of a user associated with a first computer presence client;
ii) send authorization to add the integrated presence system to the buddy list;
iii) receive state information of the first computer presence client from a computer presence system; and
iv) send presence information based on the state information to an integrated presence system client, which subscribes to the integrated presence system to receive the presence information for the user.

14. The integrated presence system of claim 13 wherein the control system is further adapted to create the presence information based on the state information.

15. The integrated presence system of claim 13 wherein the control system is further adapted to receive additional state information from another device capable of providing the additional state information associated with the user and wherein the presence information is further based on the additional state information.

16. The integrated presence system of claim 13 wherein the control system is further adapted to receive additional state information from a plurality of devices capable of providing the additional state information associated with the user and wherein the presence information is further based on the additional state information.

17. The integrated presence system of claim 13 wherein the control system is further adapted to subscribe the integrated presence system to the computer presence system as a second user.

18. The integrated presence system of claim 13 wherein the computer presence system is an instant messaging system.

19. The integrated presence system of claim 13 wherein the control system is further adapted to:
a) receive first indicia from a source unaffiliated with the computer presence system;
b) receive second indicia from the first computer presence client via the computer presence system; and
c) compare the first and second indicia to authenticate the user and associate the source of the first indicia with the first computer presence client, wherein the user must be authenticated to send the presence information.

20. The integrated presence system of claim 19 wherein the control system is further adapted to send a request for the second indicia to the first computer presence system client via the computer presence system.

21. The integrated presence system of claim 19 wherein the source is an interactive voice response system capable of interacting with the user via a telephony device associated with the user and the first indicia includes user information provided by the user during a voice session with the interactive voice response system via the telephony device.

22. The integrated presence system of claim 21 wherein the second indicia includes the user information provided by the user via the first computer presence client.

23. The integrated presence system of claim 22 wherein first and second indicia include a directory number associated with the telephony device

24. The integrated presence system of claim 23 wherein the user information includes a password provided by the user.

25. A computer readable media having software to allow an integrated presence system to receive state information from a computer presence system, the software comprising instructions for a computer to:
a) receive a request to add an integrated presence system to a buddy list of a user associated with a first computer presence client;
b) send authorization to add the integrated presence system to the buddy list;
c) receive state information of the first computer presence client from the computer presence system; and
d) send presence information based on the state information to an integrated presence system client, which subscribes to the integrated presence system to receive the presence information for the user.

26. An integrated presence system capable of receiving state information from a computer presence system comprising:
a) an interface; and
b) a control system associated with the interface and adapted to interact with a computer presence system in a manner emulating a buddy subscribing to the computer presence system and allowing a user to add the integrated presence system to a buddy list of the user, such that the integrated presence system will receive state information provided by the computer presence system.
